(19) United States
(12) Patent Application Publication
(10) Pub. No.: US 2005/0028659 A1
(43) Pub. Date: Feb. 10, 2005

(54) Card corner cutter

(76) Inventor: Chien-Fu Lin, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/634,188

(22) Filed: Aug. 4, 2003

(51) Int. Cl. B26D 7/00

(52) U.S. Cl. 83/167; 83/589; 83/694; 83/467.1

(57) ABSTRACT

A card corner cutter includes a body, a first blade, a handle and a second blade. The body defines a chamber with an open upper end for receiving scraps. The first blade is secured to the body and located next to the chamber. The handle is pivotally mounted on the body. The second blade is secured to the handle.

### FIELD OF INVENTION

The present invention relates to a card corner cutter and, more particularly, to a card corner cutter capable of collecting scraps.

### BACKGROUND OF INVENTION

U.S. Pat. No. 6,016,733 was issued to the applicant of the present application on 25 Jan. 2000 and is incorporated herein. As disclosed in U.S. Pat. No. 6,016,733, a card corner cutter includes a body 10, a first blade 20 secured to the body 10, a handle 40 pivotally mounted on the body 10 and a second blade 45 secured to the handle 40. The first blade 20 includes a first arched cutting edge 22. The second blade 45 includes a second arched cutting edge 46. In use, a card 80 is put on the body 10. A corner of the card 80 extends beyond the first blade 20 and below the second blade 45. The handle 40 is pivoted relative to the body 10 so that the second blade 45 is moved past the first blade 20. The second cutting edge 46 and the first cutting edge 22 cooperate so as to shear the corner from the card 80. The corner of the card 80 becomes a scrap. This conventional card corner cutter however fails to disclose any device to collect such scraps.

The present invention is therefore intended to obviate or at least alleviate the problem(s) encountered in prior art.

### SUMMARY OF INVENTION

It is the primary objective of the present invention to provide a card corner cutter capable of collecting scraps.

According to the present invention, a card corner cutter includes a body, a first blade, a handle and a second blade. The body defines a chamber with an open upper end for receiving scraps. The first blade is secured to the body and located next to the chamber. The handle is pivotally mounted on the body. The second blade is secured to the handle.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a perspective view of a card corner cutter according to a first embodiment of the present invention.

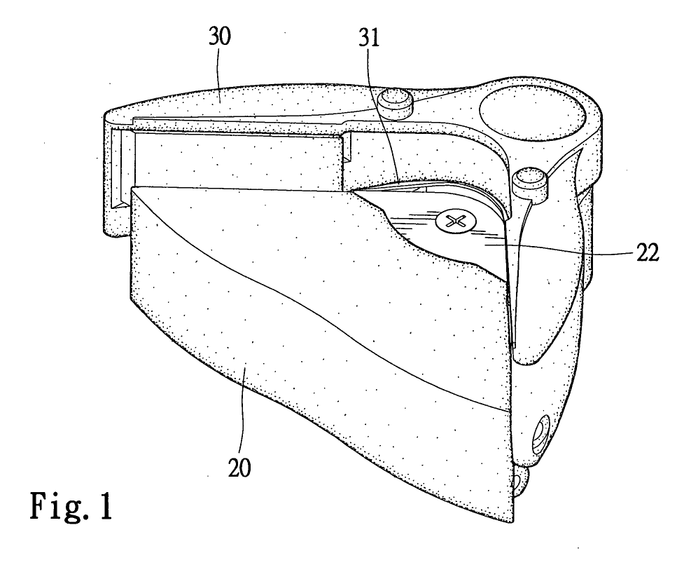

FIG. 2 is an exploded view of the card corner cutter of FIG. 1.

FIG. 3 is another perspective view of the card corner cutter of FIG. 1, showing the bottom of the card corner cutter.

FIG. 4 is a cross-sectional view of the card corner cutter of FIG. 1, showing it collecting scraps.

FIG. 5 is similar to FIG. 4, but showing the card corner cutter releasing the scraps.

FIG. 6 is an exploded view of a card corner cutter according to a second embodiment of the present invention.

FIG. 7 is a cross-sectional view of the card corner cutter of FIG. 6, showing it collecting scraps.

### DETAILED DESCRIPTION OF EMBODIMENTS

Referring to FIGS. 13, according to a first embodiment of the present invention, a card corner cutter 10 includes a body 20, a first blade 22 secured to the body 20, a chamber 21 defined in the body 20 and located next to the first blade 22, a handle 30 pivotally mounted on the body 20, a second blade 31 secured to the handle 30 and a tray 40 attached to the body 20.

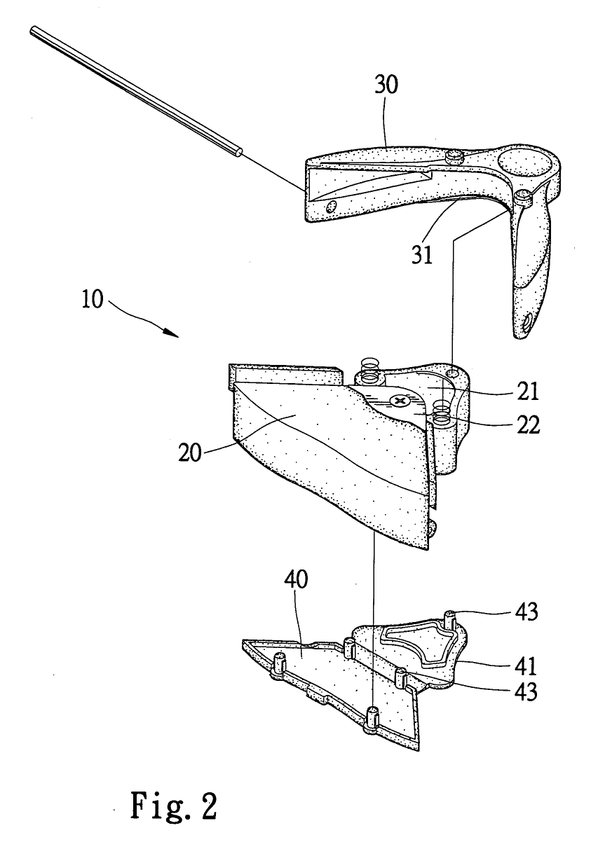

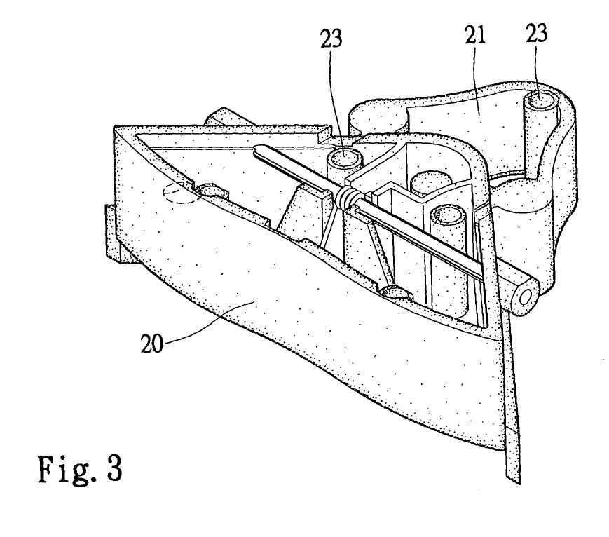

The chamber 21 includes an open upper end as best shown in FIG. 2 and an open lower end as best shown in FIG. 3. As shown in FIG. 3, a plurality of tubes 23 is formed at the bottom of the body 20. Each of the tubes 23 includes an open lower end.

Referring to FIG. 2, a plurality of columns 43 is formed on the top of the tray 40. The tray 40 includes a cover 41 pivotally formed thereon. The tray 40 is attached to the body 20 via inserting the columns 43 into the tubes 23. The cover 41 can close the open lower end of the chamber 21. One of the tubes 23 is formed on the wall of the chamber 21. One of the columns 43 is formed on the cover 41. The column 43 formed on the cover 41 can be inserted into the tube 23 formed on the wall of the chamber 21 so that the cover 41 firmly closes the open lower end of the chamber 21.

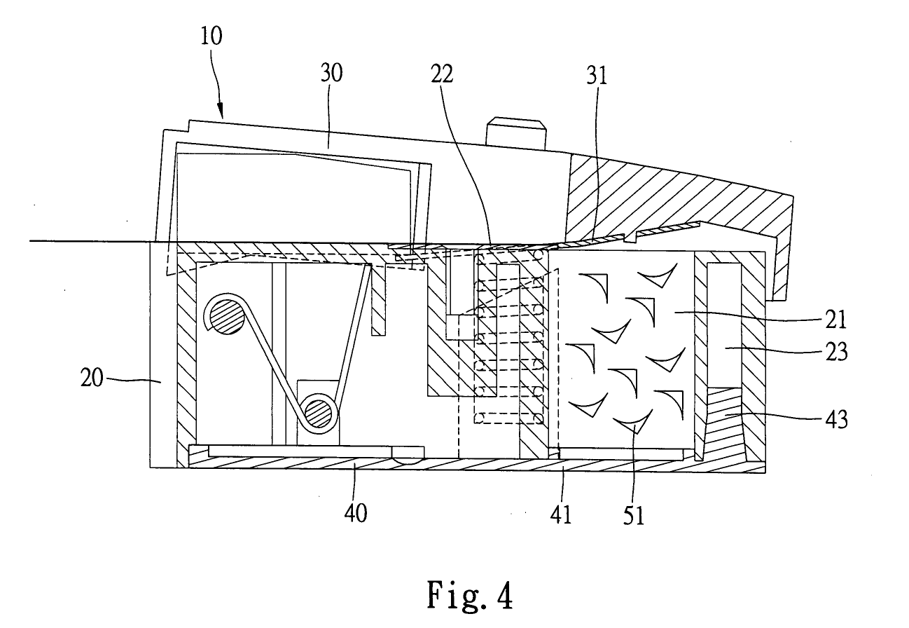

Referring to FIG. 4, scraps 51 are collected in the chamber 21 as the cover 41 closes the open lower end of the chamber 21.

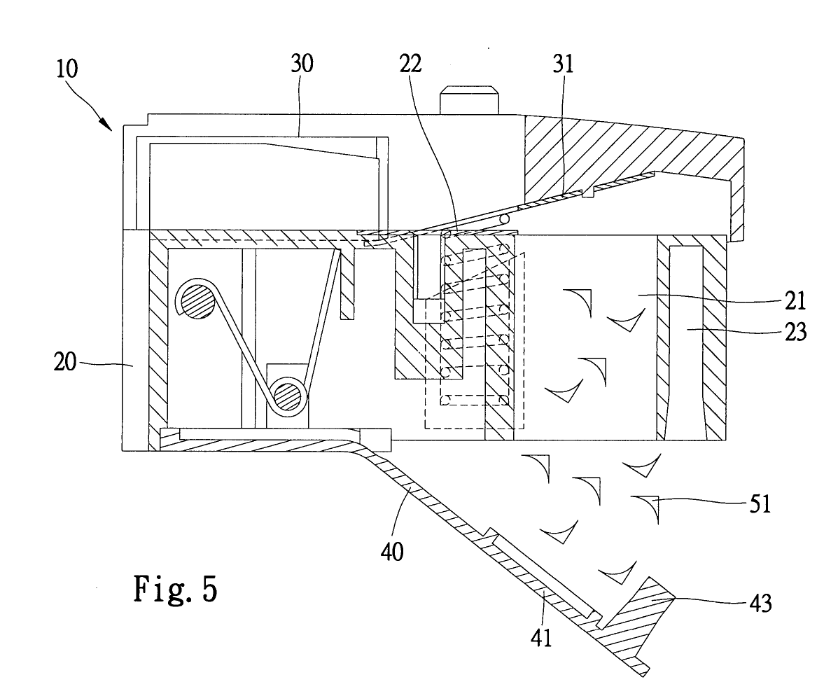

Referring to FIG. 5, the scraps 51 are released from the chamber 21 as the cover 41 is pivoted from the open lower end of the chamber 21.

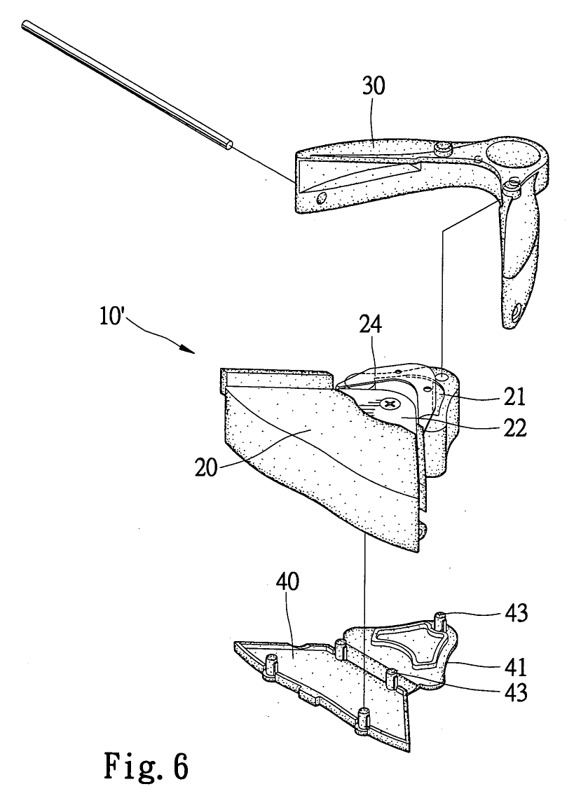

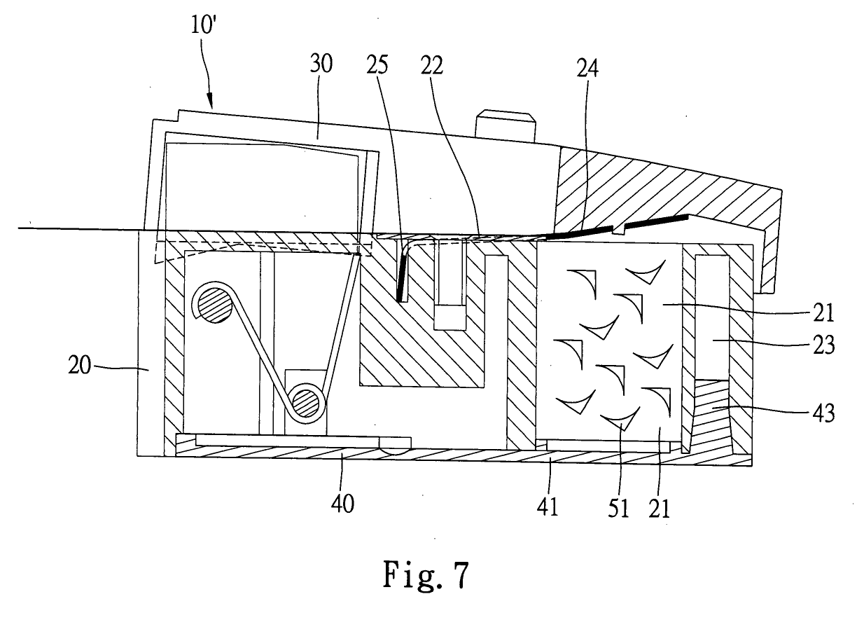

FIGS. 6 and 7 show a card corner cutter 10′ according to a second embodiment of the present invention. The card corner cutter 10′ is identical to the card corner cutter 10 except for using a second blade 24 instead of the second blade 31. The second blade 24 is pivotally mounted on the body 20 instead of secured to the handle 30. In detail, the second blade 24 is shaped as a triangle including a hypotenuse put in a recess defined in the body 20.

The present invention has been described via detailed illustration of two embodiments. Those skilled in the art can derive variations from the embodiments without departing from the scope of the present invention.

Therefore, the embodiments shall not limit the scope of the present invention defined in the claims.

1. A card corner cutter including:
a body defining a chamber with an open upper end for receiving scraps;
a first blade secured to the body and located next to the chamber;
a handle pivotally mounted on the body, and
a second blade movable past the first blade by pivoting of the handle.

2. The card corner cutter according to claim 1 wherein the chamber includes an open lower end for releasing the scraps, and the card corner cutter further includes a cover for closing the open lower end of the chamber.

3. The card corner cutter according to claim 2 wherein the cover is pivotally attached to the body.

4. The card corner cutter according to claim 3 further including a tube formed on the wall of the chamber and a column formed on the cover for insertion in the tube so that the cover firmly closes the open lower end of the chamber.

5. The card corner cutter according to claim 3 wherein the cover is a portion of a tray attached to the body.

6. The card corner cutter according to claim 5 further including a tube formed on the wall of the chamber and a column formed on the cover for insertion in the tube so that the cover firmly closes the open lower end of the chamber.

7. The card corner cutter according to claim 5 further including a plurality of tubes formed on the body and a plurality of columns formed on the top of the tray for insertion in the tubes so that the tray is attached to the body.

8. A card corner cutter including:
a body defining a chamber with an open upper end for receiving scraps;
a first blade secured to the body and located next to the chamber;
a second blade pivotally mounted on the body; and
a handle pivotally mounted on the body for pushing the second blade.

9. The card corner cutter according to claim 8 wherein the chamber includes an open lower end for releasing the scraps, and the card corner cutter further includes a cover for closing the open lower end of the chamber.

10. The card corner cutter according to claim 9 wherein the cover is pivotally attached to the body.

11. The card corner cutter according to claim 10 further including a tube formed on the wall of the chamber and a column formed on the cover for insertion in the tube so that the cover firmly closes the open lower end of the chamber.

12. The card corner cutter according to claim 10 wherein the cover is a portion of a tray attached to the body.

13. The card corner cutter according to claim 12 further including a tube formed on the wall of the chamber and a column formed on the cover for insertion in the tube so that the cover firmly closes the open lower end of the chamber.

14. The card corner cutter according to claim 12 further including a plurality of tubes formed on the body and a plurality of columns formed on the top of the tray for insertion in the tubes so that the tray is attached to the body.

15. The card corner cutter according to claim 8 wherein the second blade is shaped as a triangle including a hypotenuse put in a recess defined in the body.

16. The card corner cutter according to claim 3 wherein the second blade is secured to the handle.

17. The card corner cutter according to claim 2 wherein the second blade is secured to the handle.

18. The card corner cutter according to claim 1 wherein the second blade is secured to the handle.

19. The card corner cutter according to claim 1 wherein the second blade is pivotally mounted on the body.
